(19) United States
(12) Patent Application Publication
(10) Pub. No.: US 2019/0322245 A1
(43) Pub. Date: Oct. 24, 2019

(54) VEHICLE SENSOR CLEANING SYSTEM AND METHOD FOR OPERATING SAME

(71) Applicant: DLHBOWLES, INC., Canton, OH (US)

(72) Inventors: Zachary Kline, Burtonsville, MD (US); Russell Hester, Odenton, MD (US); Benjamin Sumpter, Ellicott City, MD (US); Thao Nguyen, Silver Spring, MD (US); Christopher Punzi, Columbia, MD (US)

(21) Appl. No.: 16/391,611

(22) Filed: Apr. 23, 2019

Related U.S. Application Data
(60) Provisional application No. 62/661,349, filed on Apr. 23, 2018.

(51) Int. Cl. B60S 1/56; B60S 1/08

(52) U.S. Cl. CPC B60S 1/56; B60S 1/087; B60S 1/0866

(57) ABSTRACT

A vehicle sensor cleaning system that includes one or more vehicle sensors and a cleaning device. The system determines parameters for a cleaning event based on sensed information, operating parameters of the vehicle, or environmental information. The system cleans the one or more sensors to allow for safe operation of the vehicle.

### CROSS-REFERENCE TO RELATED APPLICATION

This application claims priority to and the benefit of U.S. Provisional Application No. 62/661,349 entitled “VEHICLE SENSOR CLEANING SYSTEM,” filed on Apr. 23, 2018, which is incorporated herein by reference in its entirety.

### TECHNICAL FIELD

The present teachings relate to a vehicle sensor cleaning system and method, and more particularly, to a vehicle sensor cleaning system that detects operating conditions and customizes cleaning based on operating parameters.

### BACKGROUND

Some vehicles include external sensors, including external view (e.g., front bumper, side-view, rear-view or back-up) cameras to enhance the driver's vision and to improve safety. For example, rearview or “backup” camera system to minimize the likelihood of “backovers”. A backover is a specifically-defined type of accident, in which a non-occupant of a vehicle (i.e., a pedestrian or cyclist) is struck by a vehicle moving in reverse. Vehicles can include other cameras to see into any other blind spot around a vehicle's periphery (behind, to the side, or in front) and all of these cameras necessarily include exterior lens surfaces which will eventually become soiled with road grime, mud.

Vehicles can include other sensors such as infrared image sensors are incorporated to provide additional information to the driver or for autonomous driving. These vehicles may utilize sensors for object detection and location tracking and control algorithms. Such vehicles may have different levels or types of automation, such as driver assistance systems, electronic power assist steering, lane keeping assistance, adaptive cruise control, adaptive steering, blind spot detection, parking assistance, traction and brake control. The various types of automation rely on sensor input for their control.

These external sensors are exposed to the external environment and are often soiled by mud, salt spray, dirt, or other debris. Accumulating debris can distort an image, deteriorate accuracy, or may render sensor output unusable for an autonomous vehicle or vehicle controlled at least partially by an assistance system. It is therefore desirable to wash these sensing devices to reduce or eliminate the buildup of obstructive debris. It is further desirable to efficiently wash or clean external sensing devices based on operating parameters associated with a vehicle or environment.

### DESCRIPTION OF THE DRAWINGS

The present teachings may be better understood by reference to the following detailed description taken in connection with the following illustrations, wherein:

FIG. 1 is a functional schematic diagram of a vehicle sensor cleaning system in accordance with various disclosed aspects;

FIG. 2 is an exemplary chart showing transfer functions for a vehicle sensor cleaning system in accordance with various disclosed aspects;

FIG. 3 is a function diagram of a cleaning device and an external sensor of a vehicle sensor cleaning system in accordance with various disclosed aspects;

FIG. 4 is an environmental view of vehicle sensor cleaning system in accordance with various disclosed aspects;

FIG. 5 is a method associated with a vehicle sensor cleaning system in accordance with various disclosed aspects; and

FIGS. 6A and 6B are flow charts that plot one embodiment of a decision tree that is used to determine when and/or how a sensor system is cleaned.

### DETAILED DESCRIPTION

Reference will now be made in detail to embodiments of the present teachings, examples of which are illustrated in the accompanying drawings. It is to be understood that other embodiments may be utilized and structural and functional changes may be made without departing from the scope of the present teachings. Moreover, features of the embodiments may be combined, switched, or altered without departing from the scope of the present teachings, e.g., features of each disclosed embodiment may be combined, switched, or replaced with features of the other disclosed embodiments. As such, the following description is presented by way of illustration and does not limit the various alternatives and modifications that may be made to the illustrated embodiments and still be within the spirit and scope of the present teachings.

As used herein, the words “example” and “exemplary” mean an instance, or illustration. The words “example” or “exemplary” do not indicate a key or preferred aspect or embodiment. The word “or” is intended to be inclusive rather an exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggests otherwise.

“Logic” refers to any information and/or data that may be applied to direct the operation of a processor. Logic may be formed from instruction signals stored in a memory (e.g., a non-transitory memory). Software is one example of logic. In another aspect, logic may include hardware, alone or in combination with software. For instance, logic may include digital and/or analog hardware circuits, such as hardware circuits comprising logical gates (e.g., AND, OR, XOR, NAND, NOR, and other logical operations). Furthermore, logic may be programmed and/or include aspects of various devices and is not limited to a single device.

As used herein, an external sensor generally refers to a device exposed to an external environment of a vehicle to sense driving conditions, environmental conditions, or the general surroundings of the vehicle. Such external sensors may include visual light sensors or cameras (e.g., charge-coupled device, complementary metal-oxide semiconductor devices, etc.), radio detection and ranging (radar) sensors, light direction and ranging (LiDAR) sensors, and other types of sensors. Such sensors may be utilized to assist users in operation of a vehicle (e.g., blind spot monitoring, backup cameras, etc.). In another aspect, external sensors may be utilized for driverless or autonomous vehicles. Moreover, embodiments may refer to an external sensors as exposed to an external environment where the external sensor may be disposed in a housing with a lens or other shielding device separating the external sensor from direct contact with the environment. As such, the lens may be considered a portion of the external sensor that is exposed to the external environment.

Traditional vehicles do not have cleaning systems for vehicle sensors. Moreover, cleaning systems for vehicles are typically manually triggered by a user according to the user's demand. Such “on-demand” systems require a user to actuate cleaning by pressing a button on the interior of a vehicle. As such, cleaning is dependent on the user.

Described embodiments generally refer to a vehicle sensor cleaning system. A vehicle sensor cleaning system may automatically or autonomously (e.g., without user actuation) clean one or more external sensors based on a set of start-up parameters or decision tree steps. The start-up parameter set and/or decision tree for the present invention is able to determine cleaning parameters based on operating parameters associated with operation of the vehicle, an external environment, or stored preferences. For instance, the vehicle sensor cleaning system utilizes available data from the vehicle and other sources to clean sensors at operative times in an appropriate way. Some embodiments may prioritize which sensors are cleaned under which circumstances. Moreover, described vehicle sensor cleaning systems may control cleaning processes to conserve cleaning fluid, or power. As such, aspects disclosed herein may improve safety, accuracy of sensors, and environmental impacts associated with reduced use of cleaning solutions.

Both fully Autonomous Vehicles (Level 4 & 5) and vehicles that have driver assistance systems (ADAS—Level 1-3) that utilize sensors which may be cleaned by described embodiments for improved safety, reliability and function. As vehicles are exposed to debris and other environmental factors (e.g., temperature, etc.), the differing environmental conditions, vehicular situations, vehicle hardware and debris types are a few examples of real world variables or operating parameters that may be utilized by disclosed embodiments to determine an effective time to clean, method of cleaning, cleaning duration, type of fluid (types of liquid or air) or other parameters of a cleaning event. The described vehicle sensor cleaning systems may remove chances for human and/or machine error and may result in more efficient cleaning.

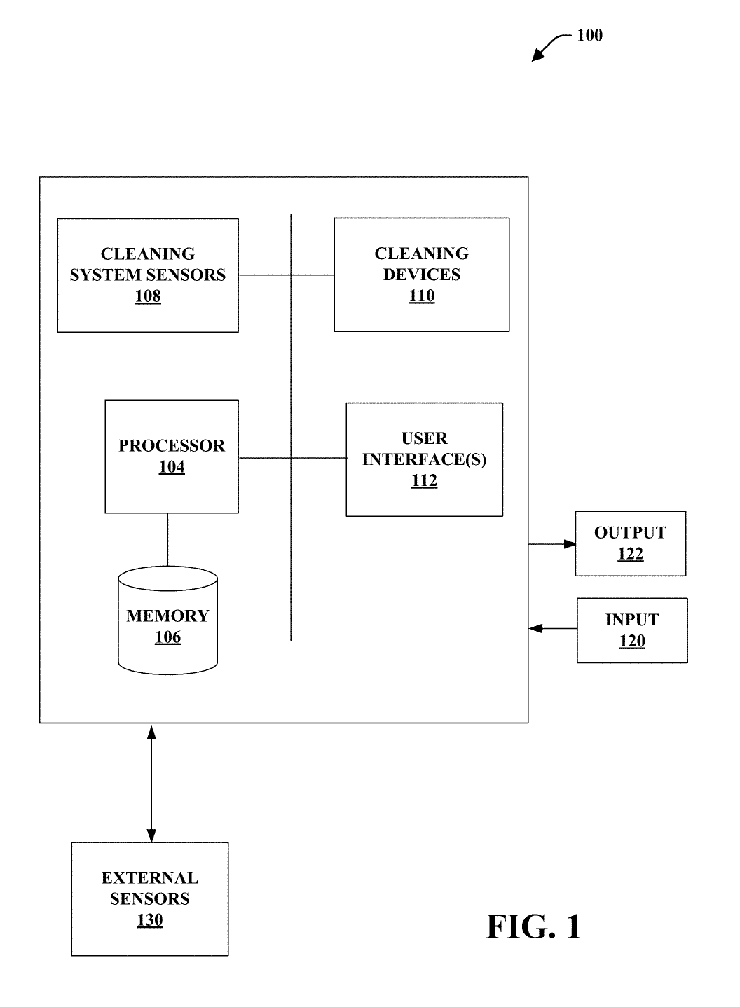

Turning to FIG. 1, there is a functional block diagram of a vehicle sensor cleaning system 100 for controlling a sensor cleaning system in accordance with various disclosed embodiments. As described herein, the vehicle sensor cleaning system 100 may primarily include a processor 104, a memory 106, cleaning sensors 108, cleaning devices 110, and user interface(s) 112. It is noted that memory 106 may store computer executable instructions which may be executed by processor 104. In an aspect, executed instructions may control or instruct the various components described herein. Furthermore, while embodiments may reference user actions, it is noted that users (e.g., humans, etc.) may not be required to perform such actions. Moreover, while shown as separate components at least for simplicity, the various components of the vehicle sensor cleaning system 100 may be comprised by a single component or multiple components. Moreover, the components may be comprised of one or more devices.

The processor 104 may receive input from cleaning sensors 108, external sensors 130, or input 120 from other sources. For instance, the processor 104 may receive input 120 from user devices (e.g., smartphone, GPS unit, etc.), a vehicle (e.g., vehicle-to-everything data), or other sources. The processor 104 may utilize the input to determine when to execute a cleaning process as described herein. The processor 104 may receive information from cleaning sensors 108 or external sensors 130 regarding ambient temperature (external to the vehicle), weather conditions (e.g. rain, clear, snow, etc.), location (e.g., based on GPS, Wi-Fi networks, triangulation, etc.), road conditions or expected road conditions, sensor types, sensor lens sizes and coating, vehicle speed, type of debris on sensor lens (e.g. mud, road spray, bugs, etc.), current outputs or items detected by cleaning sensors 108 or external sensors 130 (signal strength or object classification), or other types of information. The processor 104 may utilize some or all of this information to determine parameters for a cleaning process, such as cleaning fluid temperature, cleaning type (air or liquid), cleaning duration (air and/or liquid), cleaning flow rates (air and/or liquid), cleaning pressures (air and/or liquid), any delayed cleaning (e.g. wait to clean at a more appropriate moment), type of fluid or mixture to use (e.g., amount of alcohol to use in cleaning), or other parameters.

In at least one example, the processor 104 utilizes a predetermined set of start-up parameters and/or a decision tree that is/are initialized via one or more inputs and determines parameters for a cleaning event. The external conditions and other inputs may determine the desired parameters for the cleaning event. In an embodiment, ambient temperature may be used to determine whether a cleaning fluid should be heated, mixed with other solutions, mixed with air, pressurized at a desired pressure level or other operational parameter. For instance, the processor 104 may receive an input that represents ambient air temperature from cleaning sensors 108 or other components. The processor 104 may compare the temperature to a threshold, such as 32 degrees Fahrenheit. If below the threshold, the processor 104 may decide whether the cleaning fluid should be heated to improve performance of the cleaning event.

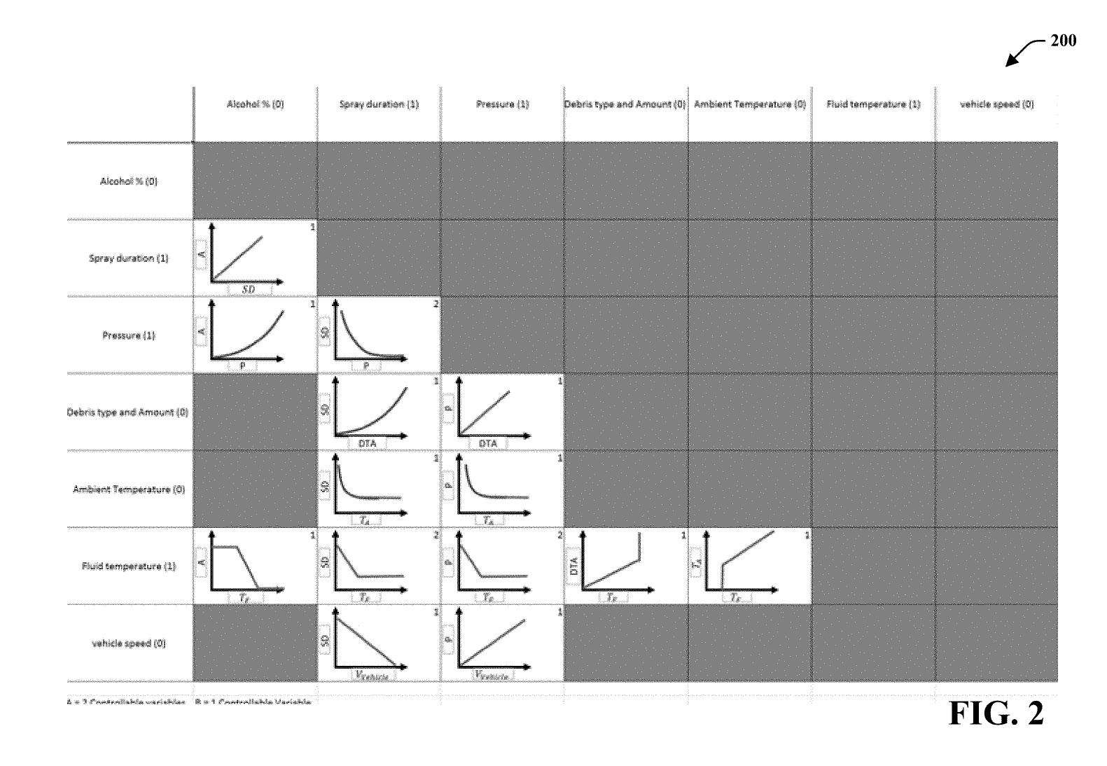

Exemplary interactions between input and determined parameters for a cleaning event are shown in FIG. 2 where a transfer function may determine output parameters for the cleaning event based on input. Sensor function may play a role in inputs/decisions and the processor 104 may consider historical information stored in the memory 106 that is related to various cleaning events, inputs, outputs and other tracked information available.

The cleaning sensors 108 may include temperature sensors, pressure sensors, wind speed sensors, tire speed sensors, light sensors, accelerometers, gyroscopes, or other devices. For example, an accelerometer may be utilized to determine road conditions (e.g., bumpy, smooth, uphill, downhill, etc.), a vehicle direction of travel (e.g., forward, reverse, etc.), vehicle speed, or other parameter. In other examples, the cleaning sensors 108 may determine operating conditions such as vehicle speed, vehicle weight, brake conditions, or road conditions. As described herein, the system 100 may utilize OEM sensors included with a vehicle or information provided by vehicle-to-everything networks. In other embodiments, the system 100 may include aftermarket or non-OEM sensors.

At least some embodiments may utilize information provided by sensors in user devices (e.g., GPS unit, smart phone, wearables, etc.) or from a network connection. For instance, the processor 104 may communicate with a separate network or database through wired or wireless connections to a transceiver. In one embodiment, the processor 104 communicates with a user's smart phone to receive GPS information and weather information. Moreover, the system 100 may receive information from a vehicle regarding brake activation, windshield wiper activation, or other vehicle operation. Such information may be utilized for determining parameters of a cleaning event.

It is noted that the processor 104 may utilize different algorithms or transfer functions for determining parameters of a cleaning event based on different use cases. For example, if a user or some automated system has activated the windshield wipers, the processor 104 may associate this with precipitation and may select appropriate transfer functions related to the control of the system.

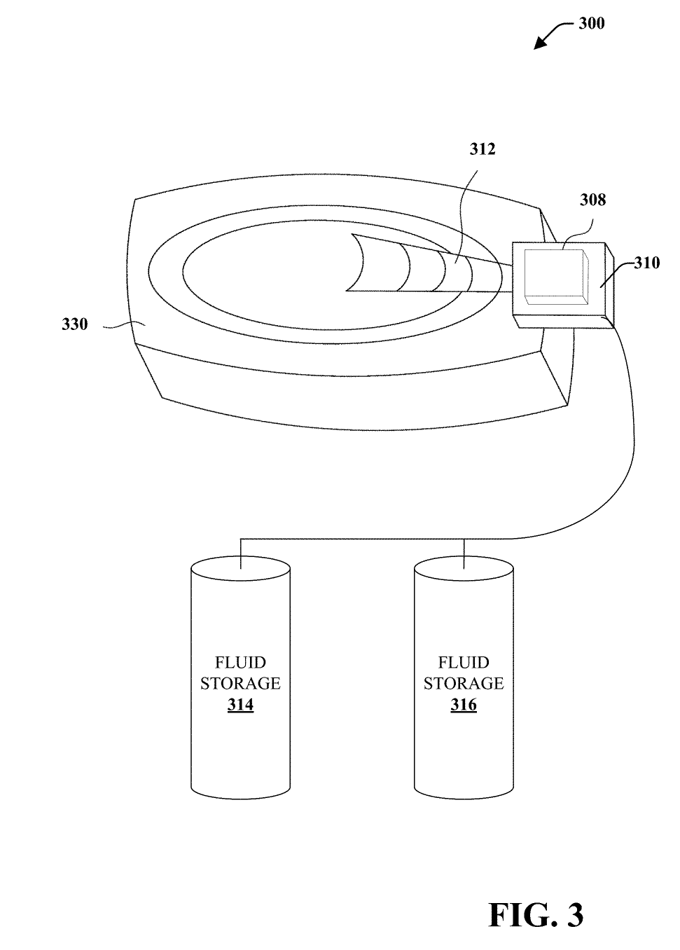

The processor 104 may additionally or alternatively utilize information related to cleaning devices 110 or external sensors 130, such as cleaning device 310 and external sensor 330 of FIG. 3. Such information may be received from the cleaning device 310, the external sensor 330, from user input via the interface 112, or provided during factory calibration.

In an example, information related to the external sensor 330 may include a make, model, dimensions, type, lens type, location of, or other information associated with the external sensor 330. Such information may additionally or alternatively include information sensed by the external sensor 330, including image information or the like. For example, the external sensor 330 may comprise a camera that captures visual information. The processor 104 may receive the visual information and may determine the presence of, type of, or location of debris. This may be done through image or pattern recognition or other debris information. The processor 104 may then determine parameters for the cleaning event based on the debris information. The parameters may include, for instance, a spray pattern 312, one or more fluids from fluid storage 314 and 316 (which may store different types of fluids), duration of cleaning, time of cleaning, or the like as described herein.

In another aspect, a cleaning sensor 308 may be disposed proximal the cleaning device 310. The cleaning sensor 308 may include an image sensor or camera that may capture images of the sensor 330. This may allow a vehicle cleaning system to capture information without requiring input from OEM sensors. It is further noted that the cleaning sensor 308 may comprise other types of sensors or may be located in other positions in accordance with various disclosed embodiments.

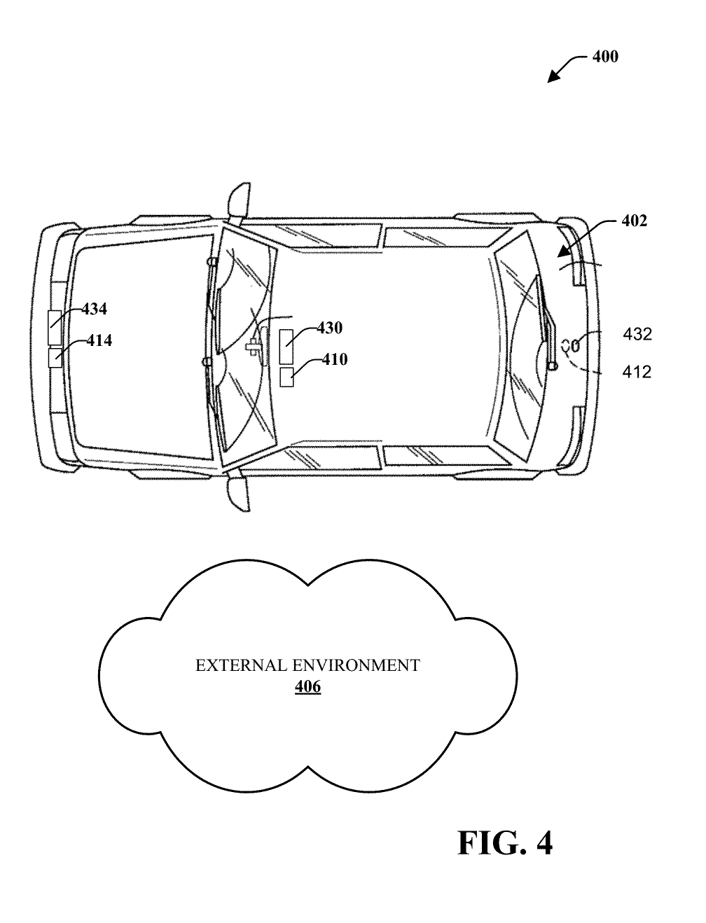

Turning to FIG. 4, there is an exemplary environmental view of a vehicle sensor cleaning system 400 for a vehicle 402. It is noted that the vehicle sensor cleaning system 400 may include similar aspects as described with reference to the other figures and the various disclosed embodiments.

The vehicle sensor cleaning system 400 may include external sensors 430, 432, 434 and associated cleaning devices 410, 412, and 414, respectively. A processor (e.g., processor 104) may be disposed in the vehicle 402, such as in a dashboard or control panel of the vehicle 402. The various external sensors 430, 432, 434 and cleaning devices 410, 412, and 414 may be located at different positions (e.g., front, back, top, side, etc.) on or within the vehicle 402 and may comprise different orientations (e.g., rear facing, front facing, side facing etc.). Moreover, the various external sensors 430, 432, 434 and cleaning devices 410, 412, and 414 may comprise different attributes, such as types of sensors, types of cleaning devices, makes or models of sensors or cleaning devices, or the like. As described herein, the processor may utilize the attributes to determine parameters for a cleaning event in conjunction with information about an external environment 406. For instance, different cleaning devices 410, 412, and 414 may comprise different capabilities or may be connected to different types of cleaning solutions, fluids, or gases (such as pressurized air). Moreover, different external sensors 430, 432, 434 may require different cleaning solutions, spray patterns, times of spray, pressure, or other parameter. The processor may utilize such information to determine intelligent parameters for a cleaning event.

In an aspect, described embodiments may utilize processing techniques, such as artificial intelligence, statistical models, or other processes and/or algorithms. These high level-processing techniques can make suggestions, provide feedback, or provide other aspects. In embodiments, master controls may utilize classifiers that map an attribute vector to a confidence that the attribute belongs to a class. For instance, master controls may input attribute vector, x=(x1, x2, x3, x4, xn) mapped to f(x)=confidence(class). Such classification can employ a probabilistic and/or statistical based analysis (e.g., factoring into the analysis sensed information, sensor attributes, cleaning device attributes, etc.) to infer suggestions and/or desired actions. In various embodiments, a processor may utilize other directed and undirected model classification approaches include, e.g., naïve Bayes, Bayesian networks, decision trees, neural networks, fuzzy logic models, and probabilistic classification models providing different patterns of independence. Classification may also include statistical regression that is utilized to develop models of priority. Further still, classification may also include data derived from another system, such as vehicle-to-everything information, user devices, or the like.

In accordance with various aspects, some embodiments may employ classifiers that are explicitly trained (e.g., via a generic training data) as well as implicitly trained (e.g., via cleaning event results, user interaction with components, user preferences, historical information, receiving extrinsic information). For example, support vector machines may be configured via a learning or training phase within a classifier constructor and feature selection module. Thus, the classifier(s) may be used to automatically learn and perform a number of functions, including but not limited to determining, according to historical data, suggestions for parameters of a cleaning event. This learning may be on an individual basis, i.e., based solely on a single user, or may apply across a set of or the entirety of the user base. Information from the users may be aggregated and the classifier(s) may be used to automatically learn and perform a number of functions based on this aggregated information. The information may be dynamically distributed, such as through an automatic update, a notification, or any other method or means, to the entire user base, a subset thereof or to an individual user.

It is further noted that described vehicle sensor cleaning systems may include manual overrides that allow a user to manually set cleaning event parameters, initiate cleaning, or the like.

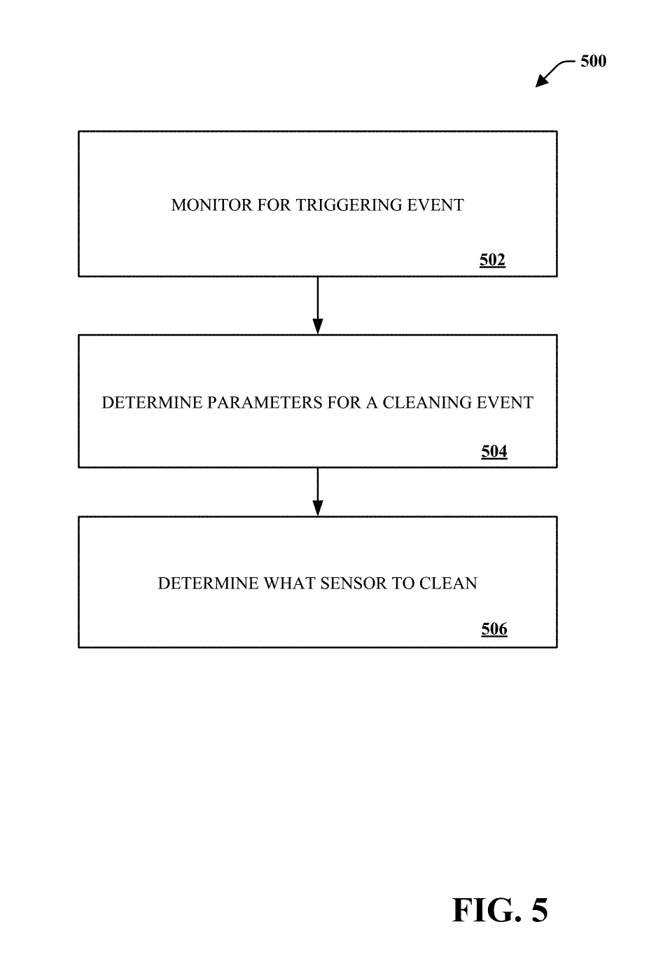

In view of the subject matter described herein, methods that may be related to various embodiments may be better appreciated with reference to the flowchart of FIG. 5. While the method is shown and described as a series of blocks, it is noted that associated methods or processes are not limited by the order of the blocks. It is further noted that some blocks and corresponding actions may occur in different orders or concurrently with other blocks. Moreover, different blocks or actions may be utilized to implement the methods described hereinafter. Various actions may be completed by one or more of users, mechanical machines, automated assembly machines (e.g., including one or more processors or computing devices), or the like.

FIG. 5 depicts an exemplary flowchart of non-limiting method 500 associated with a vehicle sensor cleaning system, according to various aspects of the subject disclosure. As an example, method 500 may determine parameters for a cleaning event.

At 502, a system, such as a vehicle sensor cleaning system, may monitor for a triggering event to initiate a cleaning event. In an aspect, the system may determine to initiate cleaning based on operating parameters of a vehicle, such as location, a level or degree of clean/dirty, type of sensor, vehicle speed, or the like. Moreover, the system may monitor for manual input by a user to initiate a cleaning event.

When utilizing LIDAR, the furthest object visible indicates a maximum range of the LIDAR. The system may cross-reference with radar to identify if there is a wall/obstruction. Moreover, the average signal amplitude for objects at X range varies based on reflectivity and an expected return signal amplitude may be based on object seen at X distance by the radar cross-referenced.

Data from imaging cameras may determine when to initiate cleaning based on a frame comparison rate and vehicle speed. Moreover, the system may identify when an image is not changing or shows less change, such as in a tunnel, at a stop, or in shadows. For instance, the system may determine to forgo a cleaning event when in a tunnel and/or to initiate cleaning when a vehicle is stopped. In some embodiments, the system may compare light intensity/brightness from light sensors to determine an intensity step change. If the change meets or exceeds a threshold, the system may allow for a cleaning event.

In other instances, the system may utilize object recognition to identify, for instance, lane markers, other vehicles, or the like. If an object is only visible in a portion of the camera, the system may determine that part of a field of view is blocked and may initiate cleaning of the camera lens. Moreover, if a vehicle comprises one or more cameras, the system may compare captured images to determine whether to clean one or more of the cameras. In another aspect, the system may utilize phase detection to identify dirt or debris that is out of focus on a camera lens. In some instances, the system may utilize contrast detection to identify when a camera is dirty by comparing the contrast to a threshold value.

In some unique cases, the system may determine the need for an immediate cleaning, such as an insect or mud splatter on a sensor. Systems with LIDAR may identify such when the return signal amplitude is consistently reduced in a small region or small percentage of sensor area by more than a threshold value. Moreover, the system may detect such when the return signal from the same object may vary in different areas of the sensor. In another aspect, a rapid change in max distance seen may trigger a cleaning event. As described herein, the system may cross-reference other signals, such as radar, to determine if an object is not seen by other sensors, thus requiring a cleaning event.

Other information, such as location may be monitored to determine whether to initiate a cleaning event. For example, the system may forgo cleaning when the vehicle is indoors. This may be determined based on sensor input (e.g., ultrasonic sensors to determine when a wall is nearby), GPS information, connectivity status to a wireless network, or the like.

The system may, as described herein, monitor a speed of the vehicle to determine when to spray a solution. For example, the system may trigger cleaning events only when the vehicle is moving or moving above a given speed.

At 504, the system may determine parameters for a cleaning event. The parameters may include, for instance: cycle times (e.g., which may be different based on temperature, contaminant, or other information); pressure (e.g., constant pressure, variable pressure, pump voltage, pump forward/reverse, or utilization of separate high and low pressure pumps); fluid attributes (e.g., multiple fluid types (bug-cleaning solution), washer fluid, air, combinations, fluid temperature, duration of different fluids, etc.); test sprays (e.g., pulse spray, then wait and re-test, respond accordingly); targeted cleaning with aim adjusted by servo; whether to utilize a ‘pre-rinse’ spray to loosen debris with a short spray prior to longer cleaning spray duration (e.g., wait duration may be tied to GPS, environment, vehicle speed, sensor location, etc.); whether and how to utilize one or more nozzles of a multi-nozzle per sensor system (e.g., clean with one nozzle strategically on a portion of a sensor as needed); or amp up of aggression of cleaning as needed if sensor is dirty or clean (e.g., such as a feedback loop to check effectiveness of cleaning at intervals—such as 0.5 s, check sensor (not clean), then clean again for longer or higher pressure or with hot fluid or steam).

It is noted that system 100 may utilize external sensor data, user input, data from one or more cleaning sensors 108 and/or 308, vehicle-to-everything data, or data from other devices to determine the parameter for the cleaning event.

At 506, the system may determine what or which sensor to clean. As described herein, the system may identify a particular sensor, portion of a sensor, or set of sensors to clean. For instance, the system may determine to clean a rear-view camera only when in reverse or may determine to clean all forward facing sensors based on a triggering event. As such, the system may utilize a distribution or zoning approach to sensor cleaning. Moreover, the system may identify priorities for cleaning based on sensor function, level of dirt/clean, or the like. For example, the front facing LiDAR may be cleaned as a priority if the vehicle is moving at a high vehicle speed (e.g. highway speed) over other sensors.

It is noted that various embodiments may clean the external sensors as they are exposed to elements and may be required to aid a user in operating a vehicle and/or for safe operation. Moreover, cleaning parameters may be set to preserve fluids and reduce waste. Further embodiments may identify an operative level of cleanliness related to sensor requirements and parameters for cleaning that may provide for the operative level of cleanliness based on environmental or operating conditions. Moreover, described embodiments may determine operative times and durations to clean such that operation of the vehicle or sensors is not interrupted. In another aspect, embodiments may identify which sensors to clean based on use, such as cleaning when a sensor is not in use, cleaning when a sensor will be needed (e.g., right hand sensor may be cleaned when turning right), or the like. Other factors, such as rate of debris accumulation, may be utilized to determine parameters of a cleaning event.

Further, cleaning of sensors may be scheduled for preemptive cleaning in preparation for a vehicle action. For example, embodiments may utilize turn signal activation or the GPS route information to identify when a turn is coming up and may schedule cleaning of key sensors for the turn in preparation to make a vehicle movement.

This system and method may be used by both fully autonomous vehicles and vehicles that have driver assistance systems. Also, this system may be incorporated into vehicles that are manually operated.

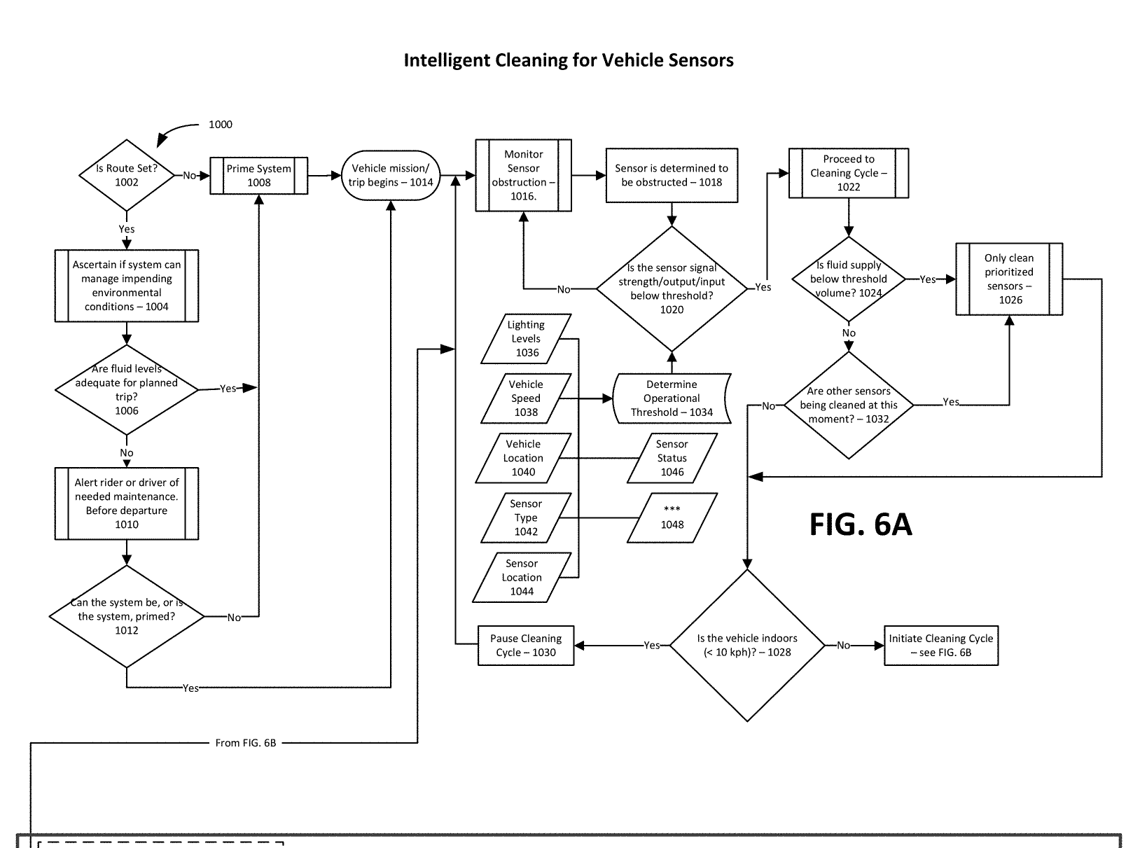

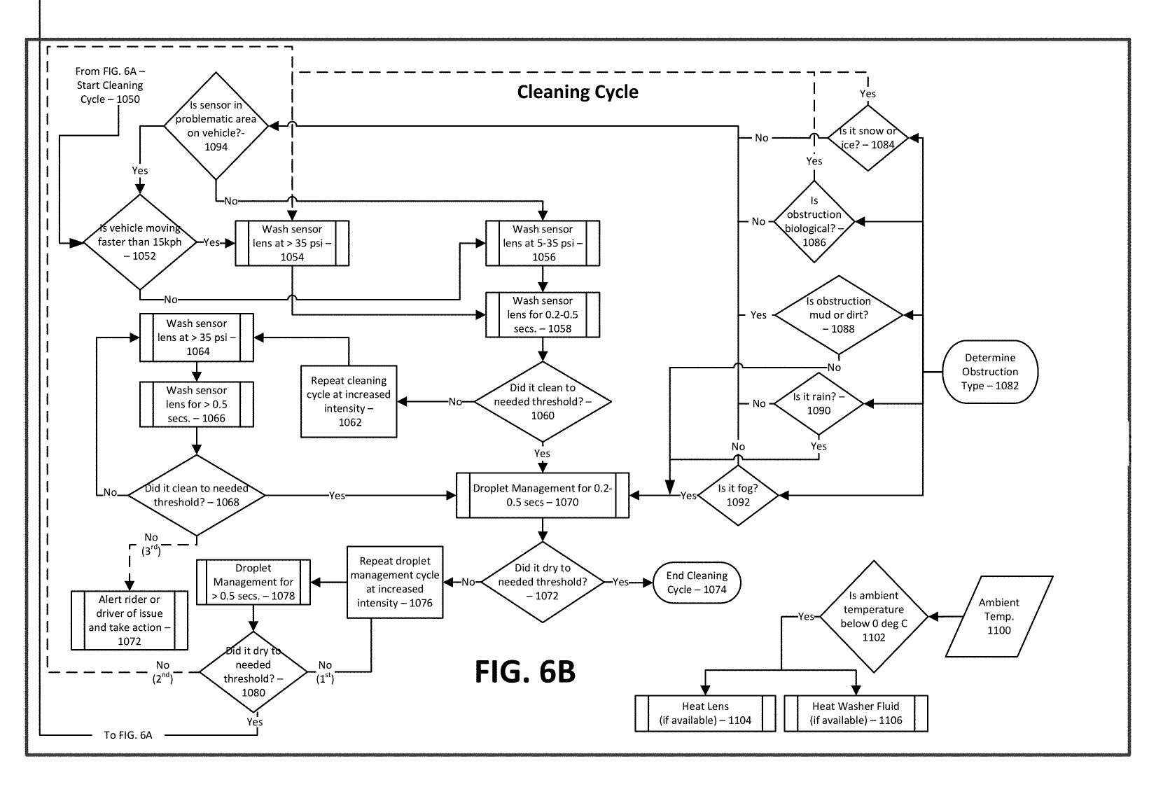

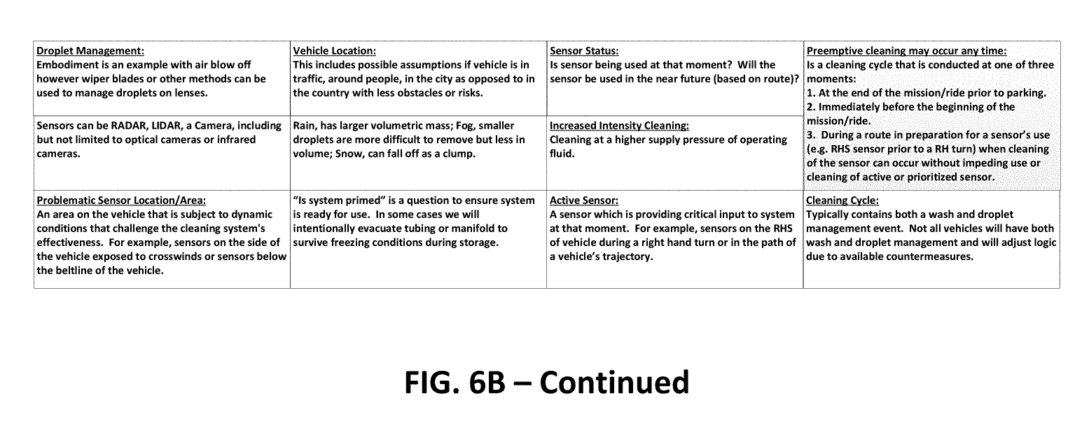

The following is a non-limiting description of a decision tree that can be utilized in connection with the present invention once a triggering event 502 (see FIG. 5) occurs. It should be noted that although FIGS. 6A and 6B are based on a triggering event of “Is route set?,” the description of the decision tree in FIGS. 6A and 6B is equally applicable to any triggering event based on vehicle location (via GPS or some other position determining system or criteria), the level or degree of cleanliness or dirtiness of one or more sensors, the type of sensor, or sensors to be utilized, vehicle speed, or the like. Given this, one of skill in the art would recognize that the triggering event of “Is route set?,” could be replaced with a query based on any of the other triggering criteria discussed above without materially altering the decision tree illustrated in FIGS. 6A and 6B. Thus, the triggering event of “Is route set?” is to only be construed as exemplary in nature and not limiting in any manner as it can be replaced, modified or changed to any suitable triggering query based on any of the other triggering criteria discussed above.

It should be noted that the present invention is not limited to just one triggering event, but can be designed so that two or more, three or more, four or more, or even fived or more triggering events need to occur prior to system 100 implementing a cleaning event based on the decision tree detailed in FIGS. 6A and 6B.

In light of the above, one exemplary decision tree 1000 for use in connection with the present invention will be described with reference to FIGS. 6A and 6B. Starting with the initial, and as previously discussed, modifiable triggering event 1002 of “Is route set?” where system 100 described above determines via one or more sensors 130 and/or inputs 120 to determine if triggering event 1002 of “Is route set?” is met and that decision tree 1000 should proceed therefrom. If the answer to triggering event 1002 of “Is route set?” is no, system 100 can still be designed to permit for priming of the cleaning system 100 as is illustrated by item 1008 “prime system.” This set up permits operation and implantation of cleaning system 100 even in the case where a pre-planned route via a GPS or some other routing method or device is not being utilized. Since the remainder of decision tree 1000 is similar in cases where the answer to triggering event 1002 of “Is route set?” is yes, a detailed description of the remainder of decision tree 1000 will be detailed below in regards to where the answer to triggering event 1002 of “Is route set?” is yes so as to avoid a lengthy duplicate discussion of the same part of decision tree 1000.

If a predetermined set of conditions are met and decision tree 1000 is ready to proceed then system 100 begins implantation of decision tree 1000 by determining if triggering event 1002 of “Is route set?” is yes which then causes the system 100 to ascertain if system 100 can manage impending environmental conditions by determining the one or more environmental conditions including, but not limited to, temperature, wind speed, ambient/environmental light level, vehicle speed, atmospheric humidity level, sensor location, sensor type, sensor cleanliness level (which can be determined via any suitable method including, but not limited to, the amount of light reaching a sensor, reflectivity of a light beam, etc.), interior vehicle temperature, interior vehicle humidity level, etc. and whether or not system 100 has sufficient cleaning ability 1004 via cleaning devices 110 by asking the exemplary query 1006 of “are fluid levels adequate for planned trip?”

It should be noted that query 1006 is only exemplary and any other suitable query can be used instead or in combination together to determine whether or not system 100 is in a suitable condition for use. Other exemplary queries for use in place of, or together with, “are fluid levels adequate for planned trip?” include, but are not limited to, “is the wind speed to high?,” “is the vehicle moving too fast and/or too slow?,” “is the ambient temperature too high or too low?,” “is the ambient humidity too high (one method by which to determine if it is raining or not) or even too low?,” etc. As would be apparent to those of skill in the art, a wide range of other queries could be formulated by using one or more of the various parameters or metrics from the various environmental conditions discussed above.

Returning to query 1006, if the answer to query 1006 is yes, then system 100 primes the system and/or one or more of the cleaning devices 110 as illustrated at item 1008. Alternatively, if the answer to query 1006 is no, then decision tree 1000 proceeds to the step of alerting a rider, or driver, that cleaning system 100 is, or may be, in needed maintenance including, but not limited to, fluid replenishment, etc. Should the maintenance issue at 1010 be resolved system 100 via decision tree 1000 may then query “can the system be, or is the system, primed?” If the answer to query 1012 is yes, then cleaning system 100 is ready to operate and the vehicle can be cleaned once the vehicle begins a trip (see item 1014) and a cleaning cycle according to FIG. 6B may be undertaken at an appropriate time. If the answer to query 1012 is no, then cleaning system 100 primes system 100 and/or one or more of the cleaning devices 110 therein (as illustrated at item 1008) and thereafter proceeds to a ready to operate state once the vehicle begins a trip (see item 1014).

As can be seen from FIG. 6A, once system 100 reaches decision tree item 1014, system 100 then either proceeds to implement a cleaning cycle according to FIG. 6B as detailed below, or goes into a standby, monitoring and/or feedback mode where system 100 determines if cleaning system 100 is ready and/or able to go into a cleaning cycle via the decision tree portion in the remainder of FIG. 6A. This portion of the overall decision tree 1000 will now be explained in detail.

This remaining portion of FIG. 6A relates to the various parameters that are utilized by themselves or in any possible combination to determine whether one or more cleaning cycles, as detailed in FIG. 6B, should be undertaken and/or implemented. Once, as described above, system 100 proceeds to a standby, monitoring and/or feedback mode where system 100 determines if cleaning system 100 is ready and/or able to go into a cleaning cycle (See item 1014), system 100 is then able to monitor one or more sensor obstruction levels (see item 1016). If one or more sensors 130 of system 100 are determined to not be obstructed (see item 1018), system 100 loops back to item 1016 (via the no line from item 1020) and continues to monitor the obstruction levels of the one or more sensor obstruction levels (see item 1016). If one or more sensors 130 of system 100 are determined to be obstructed (see item 1018), system 100 determines if the sensor signal strength/output/input is below any desired threshold level, a minimum necessary threshold level and/or some pre-determined and/or pre-set threshold (see item 1020) and then proceeds to move onto deciding if system 100 is able to institute a cleaning cycle at item 1022 by determining at item 1024 if the fluid supply in system 100 is below threshold volume. If it is (the yes line from item 1024), system 100 may still institute a cleaning cycle if need be, but will only undertake a cleaning of one or more prioritized sensors (see item 1026). In this instance, such a prioritized cleaning cycle will only proceed if the vehicle on which the one or more prioritized sensors are located is moving at more than 10 kilometers per hour (or an equivalent speed in another measurement unit such as miles per hour), see the no decision from item 1028 that leads to the box labeled “Initiate Cleaning Cycle—see FIG. 6B”. Given that the cleaning cycle of FIG. 6B will be explained below, it will be omitted here for the sake of brevity.

If the vehicle on which the one or more prioritized sensors are located is moving at less than 10 kilometers per hour (or an equivalent speed in another measurement unit such as miles per hour), see the yes decision from item 1028, then decision tree 1000 and system 100 will act to pause and/or not start a cleaning cycle (generically referred to as “Pause Cleaning Cycle —1030”) and return the system to monitor the obstruction levels of the one or more sensor obstruction levels (see item 1016).

Alternatively, if at item 1024 system 100 determines that the fluid supply is adequate (i.e., that is it is above a threshold volume), system 100 via the no line from item 1024 in decision tree 1000 next determines if other sensors are being cleaned at this moment (see item 1032). If item 1032 is determined to be yes, decision tree 1000 proceeds to item 1026 where system 100 undertakes a cleaning of one or more prioritized sensors (see item 1026). In this instance, such a prioritized cleaning cycle will again only proceed if the vehicle on which the one or more prioritized sensors are located is moving at more than 10 kph (i.e., kilometers per hour—or an equivalent speed in another measurement unit such as miles per hour), see the no decision from item 1028 that leads to the box labeled “Initiate Cleaning Cycle—see FIG. 6B”. Given that the cleaning cycle of FIG. 6B will be explained below, it will again be omitted here for the sake of brevity.

If item 1032 is determined to be no, decision tree 1000 proceeds to item 1028 where it is determined if the vehicle on which one or more sensors are located is moving at more than 10 kilometers per hour (or an equivalent speed in another measurement unit such as miles per hour). If the answer to this query is no, then the decision from item 1028 leads to the box labeled “Initiate Cleaning Cycle—see FIG. 6B”. Given that the cleaning cycle of FIG. 6B will be explained below, it will again be omitted here for the sake of brevity. If the answer to the query at item 1028 is yes, then decision tree 1000 and system 100 will act to pause and/or not start a cleaning cycle (generically referred to as “Pause Cleaning Cycle —1030”) and return the system to monitor the obstruction levels of the one or more sensor obstruction levels (see item 1016).

As can be seen from item 1020, the query “is the sensor signal strength/output/input below threshold?” can be determined by any number of parameters detailed as inputs the item 1034 where system 1000 determines one or more operational thresholds based on one or more of: external, or ambient, lighting levels (see item 1036); vehicle speed (see item 1038); vehicle location (via GPS or some other location service or method—see item 1040); sensor type (see item 1042); sensor location (via GPS or some other location service or method—see item 1044); sensor status of one or more sensors 130 (see item 1046); and/or any other desired parameter/input or metric via item 1048 (represented by *** in FIG. 6A). Item 1034 then feeds such information to decision item 1020 in decision tree 1000 and the yes and no decisions generate the results already detailed above.

As can be seen from FIG. 6B, a cleaning cycle according to one embodiment of the present invention commences via input 1050 to decision item 1052 where system 100 via decision tree 1000 determines “is the vehicle moving faster than 15 kph (i.e., kilometers per hour—or an equivalent speed in another measurement unit such as miles per hour).” If the answer to query 1052 is yes, then the one or more sensors 130 of system 100 are washed at a pressure of at least about 35 psi. If the answer to query 1052 is no, then the one or more sensors 130 of system 100 are washed at a pressure in the range of about 5 psi to about 35 psi (see item 1056). In both instances, items 1054 and 1056, the one or more sensors 130 in system 100 are washed for any suitable amount of time including, but not limited to, a washing time in the range of about 0.1 seconds to about 1 second, or from about 0.15 seconds to about 0.75 seconds, or even about 0.2 seconds to about 0.5 seconds. Thereafter, decision tree 1000 proceeds to determine at item 1060 if the one or more sensors 130 of system 100 that have been cleaned at items 1054/1058 or items 1056/1058 to some pre-determined threshold at decision item 1060.

If, at decision item 1060, the answer is determined to be no, then the cleaning cycle of decision tree 1000 proceeds to repeat cleaning cycle at increased intensity at item 106 washing such one or more sensors 130 of system 100 at a washing pressure of at least about 35 psi (see item 1064) for a washing time of at least about 0.5 seconds, at least about 0.75 seconds, at least about 1 second, or even at least about 1.25 seconds (see item 1066). Next, a query at item 1068 determines is the one or more sensors 130 in question have been cleaned to a needed threshold. If the answer to query 1068 is yes, cleaning process of decision tree 1000 proceeds to a droplet management cycle at item 1070 for a droplet management time (which is akin to a drying time) in the range of about 0.1 seconds to about 1 second, or from about 0.15 seconds to about 0.75 seconds, or even about 0.2 seconds to about 0.5 seconds. If the answer to query 1068 is no, cleaning process of decision tree 1000 proceeds back to washing pressure of at least about 35 psi (see item 1064) and cycles through items 1064, 1066 and 1068 up to two more times, at which point if the answer to query 1068 is yes the cleaning process proceeds as described above to item 1070. If on the third extra attempt the answer to query 1068 is still no, then the cleaning process of decision tree 1000 proceeds to item 1072 where system 100 alerts a vehicle occupant (a rider or driver) of a cleaning issue and instructs same to take appropriate action or take the vehicle in for service.

If, at decision item 1060, the answer is determined to be yes, then the cleaning cycle of decision tree 1000 proceeds to a droplet management cycle at item 1070 for a droplet management time (which is akin to a drying time) in the range of about 0.1 seconds to about 1 second, or from about 0.15 seconds to about 0.75 seconds, or even about 0.2 seconds to about 0.5 seconds. After item 1072, decision tree 1000 proceeds to determine at item 1072 whether or not the droplet management cycle at item 1070 accomplished a suitable amount of drying as determined by a pre-set threshold. If yes, the cleaning cycle of decision tree 1000 ends at item 1074 with the one or more sensors 130 of system 100 being suitably clean. If the answer to query 1072 is no, then droplet management (i.e., drying) is repeated one more time at item 1076 at an increased intensity or duration at item 1078 (at least about 0.5 seconds, at least about 0.75 seconds, at least about 1 second, etc.). Next system 100 via decision tree 1000 determines at item 1080 whether or not the one or more sensors 130 of system 100 dried to a needed threshold. If yes, then system 100 returns to monitoring the obstruction levels of the one or more sensor obstruction levels (see item 1016). If no, then system 100 repeats droplet management for an increased duration a second time at item 1078. After this second droplet management step at item 1078, query 1080 once again determines whether or not the one or more sensors 130 of system 100 dried to a needed threshold. If the answer to this query is no a second time, decision tree 1000 proceeds to item 1054 and loops back through the various steps of decision tree 1000 as previously described until the one or more sensors in question are cleaned in accordance with system 100 and decision tree 1000.

As can be seen from item 1082, decision tree 1000 has, in one embodiment, a built in obstruction detection routine (see items 1082, 1084, 1086, 1088, 1090 and/or 1092) where the type of obstruction occurring at one or more sensors 130 of system 100 are determine to be snow or ice (item 1084), a biological issue (i.e., a bug, a bird, or other animal—Item 1086), dirt or mud (item 1088), rain (item 1090), and/or fog (item 1092). Depending upon the answer to each of items 1082, 1084, 1086, 1088, 1090 and/or 1092 (see FIG. 6B), the process of decision tree 1000 proceeds to either droplet management cycle at item 1070 for a droplet management time (which is akin to a drying time) in the range of about 0.1 seconds to about 1 second, or from about 0.15 seconds to about 0.75 seconds, or even about 0.2 seconds to about 0.5 seconds and then onward from item 1070 as described above; or to query 1094 where it is determined if one or more sensors are in a problem area of the vehicle in question. If, at query 1094, the answer is yes, then decision tree 1000 proceeds to item 1052 and onward from there as described above. If, at query 1094, the answer is no, then decision tree 1000 proceeds to item 1056 and onward from there as described above.

In system 100 of the present invention, system 100 permits management, control and/or execution of a variety of parameters including but not limited to droplet management (akin to a form of drying) on lenses via, for example, air blow off, wiper blades or other methods can be used to manage droplets on lenses. System 100 via decision tree 1000 permits determination of vehicle location via GPS or some other location service and/or method including, but not limited to a determination of whether or not a vehicle is in traffic, around people, in the city as opposed to in the country with less obstacles or risks, etc. System 100 via decision tree 1000 permits determination of the status of one or more sensors 130 including, but not limited to, is any one specific sensor being used at any given moment and/or will any one or more specific sensor be used in the near future (based on a pre-determined route, a current route or some other factor. Sensors 130 of system 100 can be RADAR, LIDAR, a camera, including but not limited to optical cameras or infrared cameras, etc. In another embodiment, system 100 can affect an increased intensity cleaning: is any one or more pre-determined parameters are met such that a cleaning at a higher supply pressure of operating fluid occurs.

Regarding, problematic sensor location, problematic sensor locations can include, but are not limited to, an area on the vehicle that is subject to dynamic conditions that challenge the cleaning system's effectiveness such as one or more sensors on the side of a vehicle that are exposed to crosswinds or sensors below the beltline of the vehicle. Additionally, it should be noted that rain typically has larger volumetric mass, while fog is made up of smaller water droplets and is more difficult to remove. Snow and/or ice can in some instances be induced to fall off as a clump.

In one embodiment, an active sensor 130 of system 100 is a sensor which is providing critical input to system 100 at any moment. For example, sensors on the right hand side of a vehicle during a right hand turn or in the path of a vehicle's trajectory. In one embodiment, the present invention permits preemptive cleaning that may occur any time such as: (i) at the end of the mission/ride prior to parking. (ii) immediately before the beginning of the mission/ride. And/or (iii) during a route in preparation for a sensor's use (e.g. right hand side sensor prior to a right-\hand turn) when cleaning of the sensor can occur without impeding use or cleaning of active or prioritized sensor.

Although not to be limited thereto, a cleaning cycle: in accordance with one embodiment of the present invention typically contains both a wash and droplet management event. In some instances, not all vehicles will have both wash and droplet management and decision tree 1000 can be adjusted to such cases as appropriate.

In still another embodiment, cleaning cycle of decision tree 1000 can optionally contain a subroutine at items 1100, 1102, 1104 and 1106 that enable a cleaning cycle to occur at temperatures below the freezing point of water (i.e., 0 degrees C. or 32 degrees F.) via either heating the lens of one or more sensors at item 1104 or heating the washing fluid at item 1106 if it is determined at query 1102 that the ambient temperature is about 0 degrees C. or 32 degrees F. of less. If the answer to query 1102 is no then system 100 does not need to institute the subroutine to either heat one or more lenses or heat the washing fluid.

What has been described above includes examples of the present specification. It is, of course, not possible to describe every conceivable combination of components or methodologies for purposes of describing the present specification, but one of ordinary skill in the art may recognize that many further combinations and permutations of the present specification are possible. Each of the components described above may be combined or added together in any permutation to define embodiments disclosed herein. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A vehicle sensor cleaning system comprising:
one or more vehicle sensors;
one or more cleaning sensors;
one or more cleaning devices, designed to clean one or more of the one or more vehicle sensors;
at least one user interface;
at least one processor; and
at least one unit of memory,
wherein the one or more one or more vehicle sensors, the one or more cleaning sensors, the one or more cleaning devices, the at least one user interface, the at least one processor, and the at least one unit of memory act in response to one or more inputs to generate at least one output that instructs a cleaning process to occur.

2. The system of claim 1, wherein the one or more vehicle sensors are external vehicle sensors.

3. The system of claim 1, wherein the one or more vehicle sensors are external vehicle sensors selected from visual light sensors or cameras, radio detection and ranging (radar) sensors, light direction and ranging (LiDAR) sensors, or any combination of two or more thereof.

4. The system of claim 1, wherein the system is designed to be used in driverless or autonomous vehicles.

5. The system of claim 1, wherein the system is activated when a vehicle is determined to be in a desirable location by GPS.

6. The system of claim 1, wherein the system is activated when a vehicle is determined to be in a pre-determined environmental state.

7. The system of claim 6, wherein the vehicle sensor cleaning system is activated when a certain weather, or climatic, event is determined to have occurred.

8. The system of claim 7, wherein the vehicle sensor cleaning system is activated when a certain temperature threshold is reached.

9. The system of claim 6, wherein the vehicle sensor cleaning system is activated when a certain level of dirt, dust or mud is detected on one or more of the vehicle sensors.

10. The system of claim 6, wherein the vehicle sensor cleaning system is activated when one or more biological obstructions are detected.

11. The system of claim 1, wherein the one or more cleaning sensors are selected from one or more temperature sensors, one or more pressure sensors, one or more wind speed sensors, one or more tire speed sensors, one or more light sensors, one or more accelerometers, one or more gyroscopes, one or more GPS location sensors, or combinations of any two or more thereof.

12. A method for cleaning a vehicle sensor system, the method comprising the steps of:
(A) determining if one or more triggering events have occurred;
(B) determining if the system of claim 1 via is one or more cleaning sensors and/or one or more cleaning devices are in an operable state;
(C) determining if the system of claim 1 can manage one or more pre-determined, or pre-detected, environmental conditions and/or vehicle conditions;
(D) if the answer to Step (C) is yes, instituting at least one cleaning cycle for at least one for one or more vehicle sensors of the system of claim 1.

13. The method of claim 12, wherein Step (C) includes determining one or more operation thresholds of:
(i) external, or ambient, lighting levels;
(ii) vehicle speed;
(iii) vehicle location (via GPS or some other location service or method);
(iv) vehicle sensor type;
(v) vehicle sensor location (via GPS or some other location service or method);
(vi) status of the one or more vehicle sensors; and/or
(vii) a cleaning fluid level in the system of claim 1.

14. The method of claim 12, wherein Step (D) includes at least the steps of:
(a) at least one washing step; and
(b) at least one drying step.

15. The method of claim 14, wherein the at least one washing Step (a) occurs at a pressure in the range of about 5 psi to about 35 psi.

16. The method of claim 14, wherein the at least one washing Step (a) occurs at a pressure of at least about 35 psi.

17. The method of claim 14, wherein the at least one washing Step (a) occurs for at least about 0.2 seconds to about 0.5 seconds.

18. The method of claim 14, wherein the at least one washing Step (a) occurs for at least about 0.5 seconds.

19. The method of claim 14, wherein the at least one drying Step (b) occurs for at least about 0.2 seconds to about 0.5 seconds.

20. The method of claim 14, wherein the at least one drying Step (b) occurs for at least about 0.5 seconds.

21. The method of claim 14, wherein the cleaning cycle of Step (D) utilizes at least one type of heated cleaning fluid.

22. The method of claim 14, wherein the cleaning cycle of Step (D) comprises heating at least one of the vehicle sensors to be cleaned.

23. The method of claim 12, wherein Step (D) is repeated a total of two or three times prior to notifying a vehicle occupant that there is an issue or problem with the system of claim 1.

24. A vehicle sensor cleaning system as shown and described.

25. A method for cleaning vehicle sensors as shown and described.
